(19) United States
(12) Patent Application Publication
(10) Pub. No.: US 2013/0233576 A1
(43) Pub. Date: Sep. 12, 2013

(54) Methods For Improving Safety Conditions And Mitigating Emergencies At A Work Site

(71) Applicants: David L. McCoy, Medicine Park, OK (US); Daryl J. Howell, Tilden, TX (US); Michael W. McCoy, The Woodlands, TX (US)

(72) Inventors: David L. McCoy, Medicine Park, OK (US); Daryl J. Howell, Tilden, TX (US); Michael W. McCoy, The Woodlands, TX (US)

(21) Appl. No.: 13/415,957

(22) Filed: Mar. 9, 2012

(51) Int. Cl. A62C 3/00

(52) U.S. Cl. 169/43

(57) ABSTRACT

A method is provided for improving safety conditions at the work site and to respond to emergencies to mitigate the damage/injuries caused by such emergencies. The method may include positioning an emergency response system at a work site. The work site may be remotely located, e.g., a distance from additional local emergency response services. An exemplary work site may be an oil field site. The emergency response system may include a fire suppression system and a medical care unit. The fire suppression system may include a pump in fluid communication with a supply tank. The supply tank may store a fire retardant material. The fire suppression system may suppress a fire by pumping the fire retardant material from the supply tank through a delivery hose and onto the fire. The fire suppression system may further include a communication system to coordinate additional emergency response services.

### CROSS-REFERENCE TO RELATED APPLICATIONS

None.

### FIELD OF THE INVENTION

The present disclosure generally relates to methods for improving safety conditions and mitigating the effects of emergencies at a work site.

### BACKGROUND

Work site emergencies and accidents are, unfortunately, all too common and often result in considerable losses in damages to property and equipment as well as injuries to personnel. Common work site emergencies include personnel injuries, fires, explosions, chemical spills/exposures, etc. Typically, such emergencies are most commonly addressed by local emergency services, e.g., workers at the work site call for help using the 911 system and then wait on the emergency services to arrive. While waiting on the emergency services to arrive, the emergency situation often continues to worsen, even with the efforts of work site personnel (e.g., fires continue to spread to additional equipment and property, personnel injuries often go untreated, or minimally treated). At remotely located work sites, e.g., remote oil field sites, this situation is often worsened because the nearest emergency services are located a considerable distance from the work site, which even further delays their arrival time. Such delays result in a substantial increase in the costs resulting from the emergencies both in equipment/property damage as well as the immediate and long term recovery of the injured personnel involved in the emergencies. Additional costs include increased insurance premiums for the owners or operators of the work site to cover such work site emergencies. As such, there is a need for improved method for improving safety conditions at the work site as well as to provide emergency response services at the work site to mitigate such emergencies. Such improved methods can provide a safety net of initial emergency response measures to save lives and property until additional emergency response services can arrive.

### SUMMARY OF THE INVENTION

According to various embodiments, a method is provided for improving safety conditions at the work site as well as to respond to emergencies to mitigate the damage/injuries caused by such emergencies. The method may include positioning an emergency response system at a work site. The work site may be remotely located, e.g., a distance from additional local emergency response services. An exemplary work site may be an oil field site. The emergency response system may include a fire suppression system and a medical care unit. The fire suppression system may include a pump in fluid communication with a supply tank. The supply tank may store a fire retardant material. The fire suppression system may suppress a fire by pumping the fire retardant material from the supply tank through a delivery hose and onto the fire. The fire suppression system may further include a communication system. The emergency responders may use the communication system to coordinate additional emergency response services. The method may also include staffing the emergency response system with one or more, or at least one emergency responder. The emergency responders may operate the fire suppression system to suppress the fire. The emergency responders may also provide medical care to an injured person using the medical care unit. In some embodiments, the method may even further include charging a fee for positioning the emergency response system and the emergency responders at the work site. The fee may be based on the number of emergency responders positioned with the emergency response system and/or the time the emergency response system is positioned at the work site. The fee may also be a recurring fee that is calculated based on a predetermined time period (e.g., a daily, a weekly, a monthly, a quarterly, or an annual time period). Various aspects may provide for the emergency responders to provide or conduct safety inspections of the work site, on a one time or recurring basis. The safety inspections may identify and mitigate potential unsafe conditions at the work site. The emergency responders may further provide or conduct safety training classes for the workers at the work site covering, for example, corporate and/or government safety compliance standards.

According to some embodiments, a method is provided for improving safety and mitigating emergencies at a work site. The method may include positioning an emergency response system at a work site. The emergency response system may include a fire suppression system and a medical care unit. The fire suppression system may include components and/or systems configured to pump a fire retardant material onto a fire so as to suppress the fire. For example, the fire suppression system may include a pump and a supply tank storing a fire retardant material, the pump being in fluid communication with the supply tank to pump the fire retardant material onto the fire. The method may also include positioning one or more, or at least one emergency responder with the emergency response system. The emergency responders may be trained, or otherwise qualified as firefighters and also as emergency medical care givers. The emergency responders may be trained or otherwise qualified to operate the fire suppression system to suppress a fire and also to provide medical care to an injured worker using the medical care unit. In some aspects, the emergency responders positioned with the emergency response system may be experienced in both firefighting techniques and also emergency medical care (e.g., Emergency Medical Technicians). The method may even further include charging a fee, or a recurring fee for positioning the emergency response system and the emergency responders at the work site. The emergency response system and emergency responders may be positioned at a remote work site, e.g., an oil field site. The emergency responders may, for an additional fee, conduct safety inspections of the work site to identify and mitigate potential unsafe conditions on the work site.

According to even further embodiments, a method is provided for improving safety conditions at an oil field site and for providing immediate emergency response services on-site. The method may include positioning an emergency response system including at least one emergency responder with the emergency response system at the oil field site. The emergency responder may be trained to operate the emergency response system to pump a fire retardant material onto a fire at the oil field site and also to provide emergency medical care to one or more injured workers at the oil field site using the medical care unit. The method may also include charging a recurring fee to an owner of the oil field site based on the length of time the emergency response system is positioned at the oil field site as well as the number of emergency responders positioned with the emergency response system. Various embodiments may provide for the emergency response system to further include a power source supplying power to the fire suppression system and the medical care unit. The emergency response system may include a communication system wherein the emergency responder can communicate with external emergency response services to coordinate additional emergency response actions. Further, the emergency response system may include a personal decontamination unit. The emergency responder may use the decontamination unit to remove an unwanted chemical from a worker at the oil field site.

### BRIEF DESCRIPTION OF THE DRAWINGS

FIG. 1 is a flow diagram showing an exemplary method of improving safety and mitigating emergencies at a work site.

FIG. 2 is a flow diagram showing an alternate exemplary method for improving safety and mitigating emergencies at a work site.

FIG. 3 is a flow diagram showing an even further alternate exemplary method for improving safety and mitigating emergencies at an oil field site.

FIG. 4 is a perspective view showing an exemplary emergency response system positioned at a work site to practice aspects of the presently disclosed methods.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

The present disclosure provides for a method of providing emergency response services and improving safety conditions at a work site. The method may provide for placing an emergency response system having one or more emergency responders at the work site, i.e., on-site emergency response services. The emergency response system and the emergency responders may be positioned at the work site on a 24 hour basis or only during operational periods of the work site, e.g., when workers are present and working at the work site. In one embodiment, the emergency response system and the emergency responder are positioned at the work site during all operational periods of the work site. The emergency responder may use the emergency response system to provide immediate response to, and mitigation of emergencies involving, for example, fire, explosions, and/or personal injury occurring on the work site. Providing such immediate emergency response may reduce the impact of the emergency in terms of equipment, material, and personnel injury or loss. Previously, work sites would rely on local emergency response services to respond to emergency conditions at the work site. Utilizing the present disclosure, the owners, operators, or third parties may provide for an immediate emergency response capability on-site as well as heightened safety condition monitoring. Work sites utilizing the herein disclosed methods may realize an improved safety record at the work site and also reduced damages caused by emergencies because of the immediate response capability described herein.

The methods provided herein may provide for immediate experienced and trained medical first responders/firefighters at remote locations to provide a safety net of initial response measures to save lives and property until local support arrives. Additional aspects may provide for ongoing site safety, education, and monitoring services. The present methods improve loss prevention, lower insurance costs, and provide an enhanced safety profile for the work site. Aiding in the loss of life prevention by administering CPR/defibrillation as well as coordinating with local emergency response services is also provided. The present disclosure may also limit the loss of time, production, and money by keeping workers at the work site focused on their job.

The present methods may reduce the long term effects of traumatic injuries sustained on the work site by immediately providing proper medical care and first aid after an accident. Aiding in the prevention or minimizing of loss of vehicles, structures, and equipment from fire or explosion may also be provided with the emergency responders using the emergency response system including the fire suppression system.

Broadly, the emergency response system may include a fire suppression system configured to permit the emergency responder to fight or suppress a fire or an explosion at the work site by applying a fire retardant material onto the fire from a safe distance. It is to be understood that, while the fire suppression system might include a fire extinguisher as one component, the fire suppression system is not limited to a fire extinguisher and, instead, implements a wide range of firefighting techniques and materials. The fire suppression system preferably includes a storage tank(s), pumps, hoses, valves, fittings, and combinations thereof, to permit the emergency responder to apply a fire retardant material onto a fire from a safe distance (e.g., greater than 50 feet, 100 feet, or 150 feet away from the fire). The fire suppression material may further include hoses, pipes, fittings, valves, and the like so as to combine the fire retardant material with a second fire material (e.g., foam and water) and to deliver the combined fire retardant materials onto the fire.

The emergency response system may also include a medical care unit. The emergency responder may utilize the medical care unit to provide medical care to injured persons or workers at the work site. The medical care unit may include supplies, equipment, and the like, and may also be sized and/or shaped to permit the emergency responder to provide emergency medical care to an injured worker at the work site. The medical care unit may provide a climate controlled environment for the emergency responder to provide emergency medical care to the injured worker. The medical care unit may include a gurney to permit the emergency responder to recover the injured worker from the location of the injury and to transport the injured worker to the medical care unit so as to receive medical care therein.

The emergency response system may further include a personal decontamination unit. The decontamination unit may be used by the emergency responder to remove chemicals from a work site worker.

For an exemplary emergency response system considered within the scope of the present disclosure, see Applicants' co-pending patent application entitled “EMERGENCY RESPONSE SYSTEM,” filed on Mar. 9, 2012, and identified by Ser. No. 13/415,929, the contents of which are incorporated herein by reference in its entirety.

In one embodiment, the emergency responders positioned with, or staffing the emergency response system are cross-trained, experienced, and/or certified as both firefighters and medical care providers. The emergency responders may be trained, experienced, or otherwise qualified to operate the fire suppression system so as to extinguish, control, or otherwise mitigate a fire or explosion at the work site and also to provide emergency medical care to injured workers on-site. In one embodiment, one emergency responder is positioned with, or staffs the emergency response system wherein that emergency responder is cross-trained as a firefighter and as an emergency medical care provider. For instance, the emergency responders may be certified by the National Fire Protection Academy (NFPA) and trained to respond to and fight fires generally or specific to a particular work site, e.g., fires specific to oil field drilling and production facilities including foam and dry chemical stand downs. The emergency responders may also be certified as Emergency Medical Technicians (EMT) at the Basic, Intermediate, or Paramedic level (i.e., EMT-B, EMT-I, or EMT-P). Utilizing the medical care unit, the emergency responders may provide emergency medical care to injured workers immediately after the injury has occurred, thus minimizing the effects of the injury and reducing the recovery time for the worker. The medical care unit may provide an environmentally controlled location for the emergency responders to treat the injured. And lastly, the emergency responders may further be trained, certified, or otherwise skilled in personal decontamination techniques, hazardous materials training, etc.

In one aspect, the owner/operator of the work site may provide for the herein described methods, i.e., may position an emergency response system and the emergency response system at the work site. Other aspects may provide for a third party to practice the herein described methods and to charge a fee for providing the herein described services. The fee may be charged to an owner of the work site and may be based on, for example, how long the emergency response systems are positioned at the work site and also how many emergency responders are positioned with the system. The fee may be a recurring fee and may be based on a predetermined time period, e.g., a daily, a weekly, a monthly, a quarterly, and/or an annual time period. A discount may be provided to the owner/operator of the work site for contracting with the third party to provide the herein described methods for a predetermined time period.

Work site owners and/or operators may benefit from paying a fee for the present methods by improving the safety conditions on the work site and minimizing the effects of any accidents and/or emergencies that occur on the work site. Having the emergency response system and the emergency responders positioned at the work site improving the safety conditions may also provide for reduced insurance premiums for the work site owners and/or operators. Further, minimizing the effects of an emergency may reduce any resultant liability incurred because of the accident giving rise to the emergency, i.e., may show a heightened commitment to safety and emergency response capabilities by the work site owner/operator.

Additionally, the emergency responders staffing or positioned with the emergency response system may further improve site safety conditions by conducting site safety inspections. The emergency responders conducting the site safety inspections may identify any potentially unsafe conditions on the work site and provide instructions on how to mitigate or eliminate the unsafe condition. The emergency responders may provide other assistance on identified potentially unsafe conditions so as to reduce the chance of accidents/emergencies. The emergency responders may also be trained, experienced, and/or certified as industry safety inspectors by the relevant industrial or government certifying agencies. The inspections may be conducted once, e.g., when the emergency response system is first positioned at the work site or before being positioned on the work site. The safety inspections may also be conducted on a recurring basis in order to identify newly developed unsafe conditions and/or to monitor previously identified unsafe conditions. In certain embodiments, an additional fee may be charged for the site safety inspections.

Even further, the emergency responders may conduct safety training classes on-site for the workers. The safety training classes may cover such topics as corporate safety policies, government safety guidelines (e.g., OSHA, NFPA, etc.). The emergency responders providing the on-site safety training classes may raise the overall level of safety awareness for work site workers, thereby potentially reducing work site accidents/emergencies.

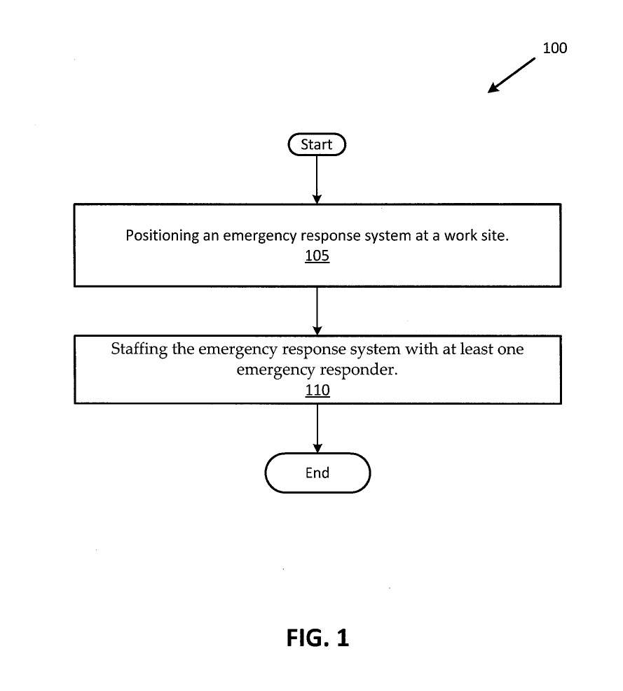

Turning to the figures now and in particular to FIG. 1, shown therein is a flow diagram of an exemplary method 100 of improving safety and mitigating emergencies at a work site. The method 100 may be utilized by an owner/operator of the work site or by a third party who charges a fee to practice the method for the benefit of the work site owner/operator. The method 100 may include a step 105 of positioning an emergency response system at the work site. The emergency response system may include a fire suppression system and a medical care unit. The fire suppression system may pump a fire retardant material from a supply tank and onto a fire. The medical care unit may be used by the emergency responder to provide emergency medical care to an injured worker on-site. The emergency response system may further include a personal decontamination unit, a communication system, and/or a power source.

The method 100 may further include a step 110 of staffing the emergency response system with at least one emergency responder. The emergency responder may be positioned with the emergency response system and use the emergency response system to fight or otherwise mitigate a fire at the work site and also to provide emergency medical care to an injured worker. The emergency responder may be trained, certified, or otherwise skilled as a firefighter and as an emergency medical care giver. The emergency responder may also be trained, certified, and/or otherwise qualified to decontaminate workers exposed to unwanted chemicals, debris, or other contaminants. The cross-trained emergency responder may provide immediate response to, and mitigation of a fire or a medical emergency occurring on the work site. The emergency responder may also coordinate with local emergency response services for additional or follow-on responses.

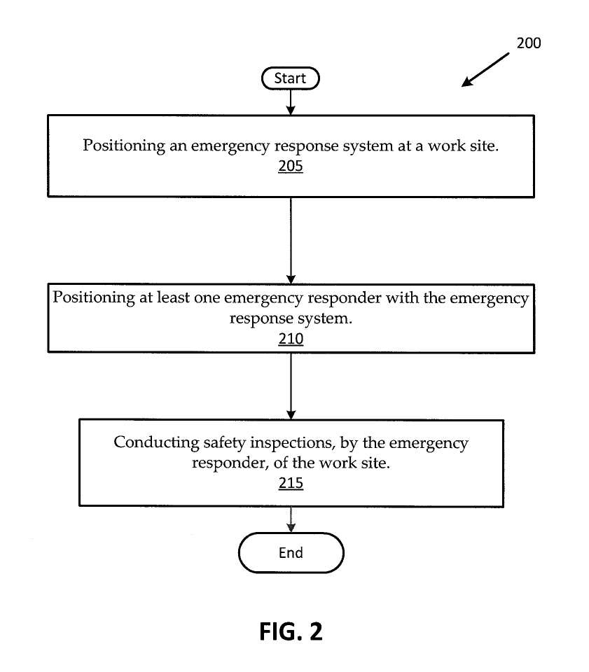

FIG. 2 shows a flowchart of an alternate embodiment of an exemplary method 200 of improving safety and mitigating emergencies at a work site. The method 200 may include a step 205 of positioning an emergency response system at a work site. The emergency response system may include a fire suppression system and a medical care unit. The fire suppression system may include a supply tank storing a fire retardant material (e.g., water, foam, etc.). The supply tank may be in fluid communication with a pump. The pump may pump the fire retardant material from the supply tank and onto a fire. The pump may be rated or otherwise configured to provide sufficient pressure to pump the fire retardant material onto the fire from a safe, or predetermined distance. The predetermined distance may be 50 feet, 100 feet, 150 feet, or farther. The medical care unit may be used by an emergency responder to provide immediate emergency medical care to an injured worker on-site.

The method 200 may further include a step 210 of positioning at least one emergency responder with the emergency response system. The emergency responder may be trained as a firefighter and as an emergency medical care giver. The emergency responder may be certified as a firefighter by the NFPA and also certified as an EMT. The emergency responder may use the fire suppression system to suppress a fire at the work site. The emergency responder may use the medical care unit to provide medical care to an injured worker at the work site. The medical care unit may provide a climate controlled environment for the emergency responder to provide the medical care to the injured worker.

The method 200 may further include a step 215 of conducting safety inspections, by the emergency responder, of the work site. The emergency responder may inspect the work site to identify and mitigate any potentially unsafe conditions at the work site. Conducting the safety inspections may provide for an enhanced safety condition at the work site and may prevent and/or reduce the number of emergencies occurring on the work site. The safety inspections may be repeated, i.e., on a recurring basis. The method 200 may be implemented by an owner/operator of the work site or by a third party. When implemented by a third party, a fee may be charged to the owner/operator of the work site for providing said services.

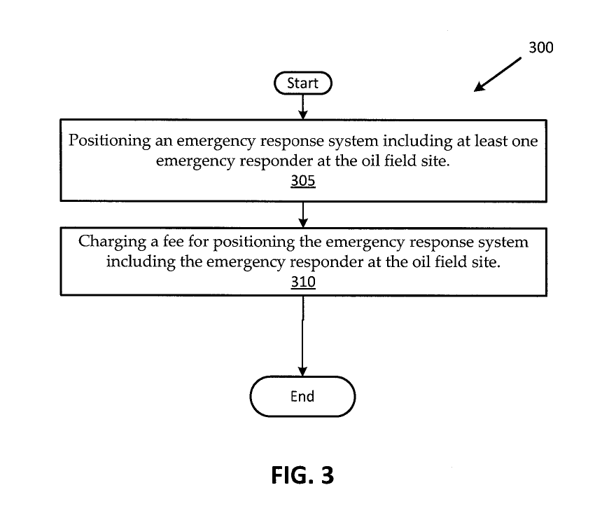

FIG. 3 shows a flow diagram of an exemplary method 300 of improving safety and mitigating emergencies at an oil field site. The method may include a step 305 of positioning an emergency response system including an emergency responder at the oil field site. The oil field site may be remotely located. The emergency responder may be trained to operate the emergency response system to pump a fire retardant material onto a fire at the oil field site and to provide emergency medical care to an injured worker at the oil field site. The emergency responder may provide the medical care to the injured worker using the emergency response system. The emergency responder may be cross-trained in both firefighting techniques and emergency medical care techniques. The emergency response system may include a decontamination unit and the emergency responder may be further trained to use the decontamination unit to decontaminate a worker exposed to an unwanted chemical.

The method 300 may further include a step 310 of charging a fee for positioning the emergency response system including the emergency responder at the oil field site. The fee may be based on the length of time the emergency response system is positioned at the oil field site. The fee may also be based on the number of emergency responders positioned with the emergency response system. The fee may be a recurring fee. The fee may be charged by a third party providing the herein disclosed methods to an owner/operator of the oil field site.

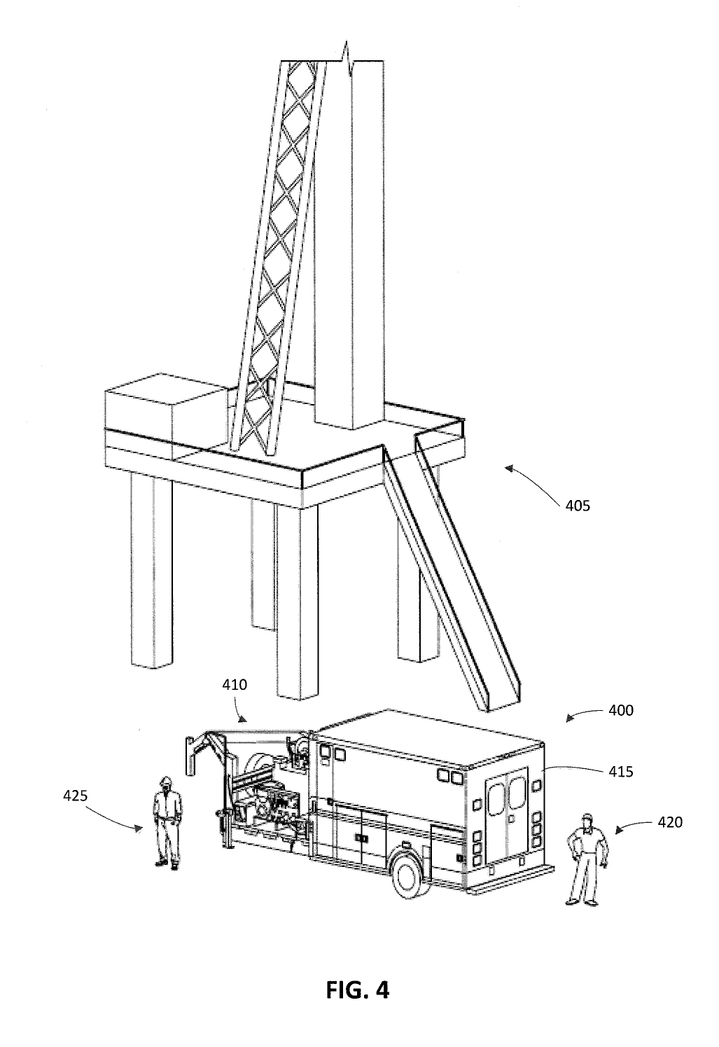

As discussed herein, the present methods generally provide for positioning an emergency response system at a work site, e.g., an oil field site. FIG. 4 is a scene view showing an exemplary emergency response system 400 positioned at an oil field site 405. The emergency response system 400 may include a fire suppression system 410 and a medical care unit 415. An emergency responder 420 may be positioned with, or otherwise staff the emergency response system 400. The emergency responder 420 may be cross-trained to use the fire suppression system 410 to fight or otherwise suppress a fire at the oil field site 405 and also to use the medical care unit 415 to provide medical care to an injured worker 425 on-site, i.e., immediately after the injury. The emergency response system 400 may include a power source, a decontamination unit, and/or a communication system. The power source may provide power to the medical care unit 415 and to a pump of the fire suppression system 410. The pump may pump a fire retardant material onto the fire. The emergency responder 420 may be trained to use the decontamination unit to decontaminate the worker 425 who may have been exposed to unwanted and dangerous chemicals while working on the work site. The emergency responder 420 may use the communication system to coordinate additional emergency response actions with, for example, local emergency responders. The emergency responder 420 may conduct safety inspections of the work site and may also provide safety classes to the worker 425 while on the work site. The work site may be an oil field site.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. A method of improving safety and mitigating emergencies at a work site, the method comprising:
positioning an emergency response system at a work site, the emergency response system including a fire suppression system pumping a fire retardant material from a supply tank and onto a fire, the emergency response system further including a medical care unit; and
staffing the emergency response system with at least one emergency responder, the emergency responder operating the fire suppression system to suppress the fire and the medical care unit to provide medical care to an injured person at the work site.

2. The method of claim 1, further comprising charging a fee for positioning the emergency response system and the emergency responder at the work site, wherein the fee is based on at least one of the number of emergency responders positioned with the emergency response system or the length of time the emergency response system is positioned at the work site.

3. The method of claim 2, wherein the fee is a recurring fee that is calculated based on a predetermined time period.

4. The method of claim 3, wherein the predetermined time period is a daily, a weekly, a monthly, a quarterly, or an annual time period.

5. The method of claim 1, further comprising providing safety inspections of the work site, by the emergency responders, to identify and mitigate potential unsafe conditions at the work site.

6. The method of claim 5, wherein the safety inspections are repeated on a recurring basis.

7. The method of claim 1, further comprising providing safety classes, by the emergency responder, to at least a portion of the personnel working at the work site.

8. The method of claim 7, wherein the safety classes include information regarding compliance with corporate or government safety guidelines.

9. The method of claim 1, wherein the emergency response system further comprises a communications system communicating with an external emergency response service so as to coordinate additional emergency response actions.

10. The method of claim 1, wherein the emergency response system comprises an emergency decontamination unit.

11. The method of claim 1, wherein the work site is an oil field site.

12. A method of improving safety and mitigating emergencies at a work site, the method comprising:
positioning an emergency response system at a work site, the emergency response system including a fire suppression system including a supply tank storing a fire retardant material and in fluid communication with a pump to pump the fire retardant material onto a fire from a predetermined distance, the fire suppression system further including a medical care unit;
positioning at least one emergency responder with the emergency response system, the emergency responder trained as a firefighter and operating the fire suppression system to suppress a fire, the emergency responder further trained as an emergency medical care giver to provide medical care to an injured worker using the medical care unit; and
conducting safety inspections, by the emergency responder, of the work site to identify and mitigate potentially unsafe conditions.

13. The method of claim 12, further comprising charging a fee for positioning the emergency response system and the emergency responder at the work site.

14. The method of claim 12, wherein the fee is a recurring fee and is calculated based on the number of emergency responders positioned with the emergency response system.

15. The method of claim 12, wherein the work site is a remotely located oil field site.

16. The method of claim 12, wherein the safety inspections, by the emergency responder, of the work site are repeated on a recurring basis.

17. A method of improving safety and mitigating emergencies at an oil field site, the method comprising:
positioning an emergency response system including an emergency responder at the oil field site, the emergency responder trained to operate the emergency response system to pump a fire retardant material onto a fire at the oil field site and to provide emergency medical care to one or more injured workers at the oil field site; and
charging a fee for positioning the emergency response system including the emergency responder at the oil field site, the fee based on the length of time the emergency response system is positioned at the oil field site as well as the number of emergency responders positioned with the emergency response system.

18. The method of claim 17, wherein the emergency response system further includes a power source providing power to the medical care unit and to a pump of the fire suppression system to pump the fire retardant material onto the fire.

19. The method of claim 17, wherein the emergency response system further includes a decontamination unit and the emergency responders are trained to remove chemicals from workers at the site using the decontamination unit.

20. The method of claim 17, further comprising communicating, by the emergency responders, with external emergency response services to coordinate additional emergency response services.
